(19) United States
(12) Patent Application Publication
(10) Pub. No.: US 2013/0058855 A1
(43) Pub. Date: Mar. 7, 2013

(54) METHOD OF REFORMING GASIFICATION GAS

(71) Applicants: Sami Toppinen, Helsinki (FI); Isto Eilos, Porvoo (FI); Pekka Simell, Vtt (FI); Esa Kurkela, Vtt (FI); Ilkka Hiltunen, Vtt (FI)

(72) Inventors: Sami Toppinen, Helsinki (FI); Isto Eilos, Porvoo (FI); Pekka Simell, Vtt (FI); Esa Kurkela, Vtt (FI); Ilkka Hiltunen, Vtt (FI)

(73) Assignee: NESTE OIL OYJ, Espoo (FI)

(21) Appl. No.: 13/598,299

(22) Filed: Aug. 29, 2012

Related U.S. Application Data
(60) Provisional application No. 61/530,431, filed on Sep. 2, 2011.

(30) Foreign Application Priority Data
Sep. 2, 2011 (EP) 11179907.8

(51) Int. Cl. B01D 53/44

(52) U.S. Cl. 423/245.1

(57) ABSTRACT

A method of reforming a gasification gas, in order to decompose the impurities comprised in the gas, and a use of a precious metal catalyst in the pre-reforming of gasification gas. The gas can be brought into contact with a metal catalyst in the presence of an oxidizing agent. The reformation can be carried out in several stages, in which case at least in one of the first catalytic zones a noble metal catalyst can be used, and in a secondary reforming stage which follows the first, preliminary reforming zone, the catalyst that can be used is a metal catalyst. Oxygen can be fed separately into each of the catalyst zones. The use of a noble metal catalyst can reduce the risk of deactivation of the metal catalysts and can increase the operating life of the catalyst.

### RELATED APPLICATION(S)

This application claims priority under 35 U.S.C. §119 to European Patent Application No. 11179907.8 filed in Europe on Sep. 2, 2011, the entire content of which is hereby incorporated by reference in its entirety. This application claims priority under 35 U.S.C. §119 of U.S. Provisional Application No. 61/530,431 filed on Sep. 2, 2011, the entire content of which is hereby incorporated by reference in its entirety.

### FIELD

Disclosed is a method of reforming gasification gas. Gasification gas can be contacted with a metal catalyst in a reformer in the presence of an oxidizing agent, to decompose organic impurities that are present in the gasification gas.

### BACKGROUND INFORMATION

Oxygen blown gasification or water vapor gasification of biomass, such as wood, peat, straw or logging waste, can generate gas which comprises hydrogen approximately 35 to 45% by volume, carbon monoxide 20 to 30% by volume, carbon dioxide 15 to 25% by volume, methane approximately 8 to 12% by volume, and nitrogen 3 to 5% by volume. It is possible to use this gas as, for example, a synthesis gas for producing diesel-category fuels. Steam/oxygen gasification of biomass is an interesting alternative economically, when the scale of operation is large enough.

Problems with gasification can include, for example, variations in gas composition and amounts of impurities. It is possible to purify gasification gas efficiently from tar impurities and ammonia which are contained in it by using catalysts at a high temperature. Examples of catalysts which are suitable for decomposing tar are nickel catalysts and dolomites, the operating temperatures of which can be at minimum 800-900° C. For example, gasification technology is disclosed by Pekka Simell, Catalytic hot gas cleaning of gasification gas, VTT Publications No. 330, Espoo 1997.

A zirconium catalyst (FI Patent No. 110691), which has been developed by VTT Technical Research Centre of Finland, also works efficiently in decomposing tars, for example, heavier hydrocarbons. In addition, the zirconium catalyst can enable the use of a considerably wider temperature range than does a nickel catalyst, for example, a temperature range of 600 to 900° C.

When using nickel catalysts, the high temperature employed can present a problem. Use of such high temperature can form soot (coke) during the process of the catalytic gas conditioning. The coking problem can be made worse in applications of synthesis gas, in which light hydrocarbons (for example, methane) are intended to be reformed as efficiently as possible. In this case, the metal catalysts, for example, nickel, can be used at very high temperatures (950 to 1100° C.). The generation of soot can cause accumulations of carbon deposits on the catalysts and the reactor, and may eventually result in clogging the whole reactor.

At the start-up of the gasification process, the use of nickel or other metal catalysts presents problems because the temperature in the catalytic unit is relatively low, for example, below 700° C. During the start-up, the operation of the gasifier may occasionally be unstable, and the tar content of the product gas may then occasionally rise extremely high. These conditions may together cause an accumulation of carbon on the nickel catalyst and clogging of the catalyst reactor, and accelerate deactivation of the nickel catalyst.

A catalytic reformer, which is used in the purification of gasification gas, can be heated by using partial oxidation (partial combustion) of the gas in a position before the catalyst bed or in the catalyst bed, in which case the process is called “autothermal reforming.” After the gas is oxidized, its temperature can increase considerably, in which case also thermal side reactions, i.e. coking, can take place to a growing extent.

It is possible to reduce the coking of the metal catalyst in the reformer by using phased reforming. “Phased reforming” means that the reforming is carried out in several stages, for example, several sequential catalyst zones, in which two or more catalysts are used.

According to International Publication No. WO 2007/116121 (Multiple Stage Method of Reforming a Gas Containing Tarry Impurities Employing a Zirconium-Based Catalyst, inventors: P. Simell and E. Kurkela), in the first stage of a phased reformer (“pre-reforming stage” or “pre-reformer”), a zirconium catalyst is used. While the gas is being partly oxidized in the zirconium catalyst, the heaviest tar compounds are decomposed into gas components. Almost no carbon is generated in the zirconium catalyst and, consequently, no carbon blockage of the reactor takes place.

However, results of the trial runs which were carried out show that the use of a zirconium catalyst in the pre-reformer does not always reduce the generation of coke adequately. This applies in cases where very high temperatures (for example, over 900° C.) are employed in the secondary stage. Such occasions occur, for example, in applications of synthesis gasification in which a nickel catalyst is used at high temperatures for the actual reforming.

In conditions such as these, to ensure the functionality of the process, it can be desirable to reduce or prevent the generation of coke in the first catalyst layers (preliminary reforming stage).

It has also been found that the capability of zirconium containing catalysts to achieve decomposition of tarry compounds can be dependent on temperature and that good results can be reached at relatively low temperatures (for example, about 500 to 700° C.).

### SUMMARY

According to an exemplary aspect, a method of reforming gasification gas to decompose organic impurities comprised in the gasification gas, wherein the gasification gas is contacted with a metal catalyst in the presence of an oxidizing agent, the method comprising: carrying out reforming of the gasification gas in several stages comprising, in a cascade, a first catalyst zone comprising a zirconium containing catalyst; a second catalyst zone comprising a precious metal catalyst; and a third catalyst zone comprising a metal catalyst, wherein a first oxidizing agent is fed into the first catalyst zone, and a second oxidizing agent is separately fed into the second catalyst zone, wherein the first and second oxidizing agents are of the same or different material.

### BRIEF DESCRIPTION OF THE DRAWINGS

FIG. 1 is a process flowchart of a reformer, in accordance with an exemplary embodiment;

FIG. 2 is a graph of tar content at reformer inlet, after the first stage of the reformer and at the outlet for the test reported in Example 1, in accordance with an exemplary embodiment; and

FIG. 3 is a graph of the conversion of naphthalene as a function of pressure (see Example 2), in accordance with an exemplary embodiment.

### DETAILED DESCRIPTION

According to an exemplary aspect, disclosed is a method for treating gasification gas. An exemplary aspect of the present disclosure is based on the finding that organic impurities (such as, for example, tar and light hydrocarbons, such as ethylene and butadiene) which are contained in the gasification gas can be decomposed in a catalytic reformer at a temperature of approximately 500 to 900° C., and in the presence of a precious metal catalyst, for example a noble metal catalyst, preceded upstream of a zirconium based catalyst.

This can be carried out by feeding the gasification gas into a multi-stage reforming process comprising, in a cascade, at least a first catalytic reforming zone, in which a zirconium containing catalyst is used, a second catalytic reforming zone, in which a noble metal catalyst is used, and a third catalytic reforming zone, in which a metal catalyst is used. The first and second catalytic reforming zones, forming a preliminary reforming zone, can contribute to a clear reduction in the coking of the catalyst of the third reforming zone.

During operation, an oxidizing agent, such as oxygen gas, can be mixed with the feed to the first catalytic reforming zone. An oxidizing agent, such as oxygen gas, optionally in combination with steam, can be separately fed to the second catalytic reforming zone, and optionally also into the third catalytic reforming zone.

The use of a cascade of catalyst beds with zirconium containing catalyst(s) and noble metal catalyst(s) can reduce the risk of deactivation of the subsequent metal catalysts and, consequently, can increase the operating life of this reforming catalyst. If the reactions for generating carbon can be reduced or prevented, clogging of the reactor caused by the generation of coke can be reduced or prevented. It is possible to utilize an exemplary process or system, for example, in any suitable power plants or chemical industry processes that are based on gasification and in which it can be desirable to reduce or eliminate the presence of tar in the gas. Examples of such processes can include, for example, the production of electricity from gasification gas by using an engine or a turbine (IGCC), and the production of synthesis gas, for example, for synthesis of fuels or methanol.

By feeding additional oxygen to the second and third reforming zones, the temperature profile of the novel multiple stage reforming method can be efficiently controlled and adjusted, and it has been found that the concentrations of naphthalenes and benzene can be greatly reduced.

Enhanced decomposition of tars can allow for the use of higher pressures/lower temperatures in the gasifier which can increase the economy and capacity of the process, for example, if the gasification/reforming stages are combined with a Fischer-Tropsch process. Low temperature gasification can produce high tar content. In accordance with an exemplary aspect, tar conversions can be increased remarkably which can mean higher yields for the whole process and less blocking problems at the further processing units for the syngas (gas ultrafine cleaning and conditioning).

Disclosed is the treatment of gasification gas by reforming. For example, in an exemplary aspect, the reforming can be carried out in several steps in a multiple stage reforming process.

For example, gas obtained by, for example, gasification of biomass, can be conducted to a preliminary reforming stage, in which light hydrocarbons that are contained in the gasification gas, and the heaviest tar compounds that appear as intermediate products, can be decomposed. Light compounds which are to be decomposed can include, for example, unsaturated C₁-C₆ hydrocarbons, for example, olefinic hydrocarbons. Examples of these can include C₁-C₆ hydrocarbons, such as ethylene and butadiene, which comprise one or two double bonds. After the preliminary stage, the effluent can be conducted to a secondary reforming stage wherein it is contacted with the actual reforming catalyst, for example, a metal catalyst, such as a nickel or a noble metal catalyst.

The preliminary reforming stage can comprise in a cascade at least a first catalyst zone and a second catalyst zone.

The preliminary reforming stage can be further carried out in the presence of an oxidizing agent, whereby heat can be generated in the reaction, which heat can be utilized in the actual reforming stage. For example, the oxidizing agent can be fed into the gasification gas before this agent is led into the pre-reforming stage.

According to an exemplary embodiment, an oxidizing agent (for example, oxygen gas) can be fed into the second stage of the pre-reforming. For example, it is possible to feed the oxidizing agent, as an intermediate feed, into the effluent of the first stage, before the effluent is conducted into the second stage.

Furthermore, an oxidizing agent can be fed into the third stage of the reforming process, for example, into the secondary reforming carried out in the presence of a metal catalyst. For example, the preliminary reforming stage can be significant because the role of light olefinic hydrocarbons and tar compounds in generating coke can become more pronounced when the temperature of the gas increases greatly after the pre-reforming zone. This can be the case when oxygen is fed into the secondary stage of the reformer.

In at least one or all of the applications above, for example air, oxygen or a mixture thereof can be used as an oxidizing agent. Thus, the oxidizing agent can be used, for example, in the form of pure or purified oxygen gas.

In an exemplary embodiment, the oxidizing agent, such as oxygen, which is being fed into either of the second and third catalyst zones, for example, both zones, can be mixed with a protective component, for example, a protective gas, such as steam. By using such a component it can be possible to protect any steel construction against the overheating due to oxygen feed.

The molar proportions between oxygen and water steam in the gas intermittently fed into the reforming process varies freely. The ratio can be in the range of about 0.01:1 to 1:0.01. For example, it is exemplary to have an oxygen-to-steam molar ratio of about 0.1:1 to 1:0.1, for example, 0.5:1 to 1:0.5.

In the various steps, the feed of oxidizing agent can freely be selected. The amounts can vary depending on the composition of the gasification gas which is being treated. For example, an amount can be selected which meets the preselected temperature range of each catalyst bed zone/catalyst bed. For example, the molar feed of oxygen as an oxidizing agent into the first, second and optionally third catalyst zones can in each step be in the range of 0.01 to 99%, for example, 1 to 70%, of the total feed of oxygen into the total reformer. For example, the oxygen fed together with the syngas into the first catalyst bed zone can be about 0.1 to 90 mole-%, for example, 1 to 50 mole-%, of the total oxygen feed.

For example, the temperature of the preliminary reforming stage can be in the range of 500 to 900° C. For example, the first catalytic reforming zone can be operated at a temperature of about 500 to 700° C., and the second catalytic reforming zone can be operated at a temperature of about 800 to 900° C. By selecting an operational temperature within the above temperature ranges, for example, it can be possible to further improve tar conversion. Feeding oxygen, optionally mixed with a protecting gas such as steam, can facilitate reaching of the preselected temperature.

The temperature range of the secondary stage may overlap the temperature of the preliminary stage. In an exemplary embodiment, the temperature of the secondary reforming stage can be higher than the temperature of the preliminary reforming stage. According to an exemplary embodiment, the operation in the metal catalyst reforming zone can be carried out at a temperature above 900° C., for example, at a temperature which is above 900° C. and, for example, below 1500° C.

The preliminary reforming zone, formed by the first and the second zones, can comprise at least one zirconium containing catalyst zone and at least one precious metal catalyst zone. The zirconium containing catalyst zone can be arranged upstream of the precious metal catalyst zone, for example, noble metal catalyst zone.

The zirconium containing catalyst can contain zirconium oxide. It can be possible to produce the zirconium catalyst, from zirconium oxide (ZrO₂), which is alloyed with another metal oxide, such as aluminum oxide (Al₂O₃). The percentage of zirconium oxide or a corresponding zirconium compound in the alloy can be more than 50% of the weight of the alloy.

The zirconium compound can be on the surface of an inert support, or impregnated into the support. It can also be the coating of a ceramic or metallic honeycomb.

For example, the zirconium containing catalyst can be used and produced in any suitable manner, for example, as described in FI Patent No. 110691 and International Publication No. WO 2007/116121, the contents of which are hereby incorporated by reference.

For example, the zirconium containing catalyst can decompose the heaviest tar compounds which generate carbon, and it can enhance the operation of both the noble metal catalyst and the secondary stage of the reformer.

In the second zone of the preliminary reforming stage and, possibly, in the actual reforming, a noble metal, in the following also referred to as a “precious metal,” catalyst can be used. The metal can be chosen from the metals of groups 8 to 10 in the periodic table. For example, at least one metal of the groups 8 to 10 in the periodic table, such as Ru, Rh, Pd or Pt, can act as the noble metal catalyst. The precious metal catalyst can be used as a single component or as a combination of two or more metals.

For example, it is possible to use self-supporting metal catalysts. Bearing in mind, for example, the cost of these metals, for example, and their mechanical resistance, it can be economical to use a supported catalyst, for example, a carrier or support of the catalyst. For example, metals can function on the surface of a support such as, for example, on the surface of aluminum oxide or zirconium oxide. The amount of metal in the catalyst can be within the range of 0.01 to 20% by weight, for example, 0.1 to 5% by weight, calculated from the weight of the support.

Precious metal catalysts, for example, noble metal catalysts (both for the pre-reforming and for the actual reforming) can be produced in any suitable manner. For example, the metals can be added into the support using any method which can be applied in the production of catalysts. An example of these is impregnation into the carrier. For example, the impregnation can be carried out by dispersing or by dissolving the metal or its precursor into a suitable medium, from which the metal can be attached to the support by the process of precipitating or layering. It can also be possible to bring the metal or its precursor to the support from a vapor phase, either by condensing the compound onto the surface or by binding it directly from the vapor phase to the support by means of chemisorption.

The support (which also can be called a “carrier”) can include a coating (washcoat) for instance on a particle or on a ceramic or a metallic honeycomb. It is also possible that a honeycomb or a particle works as such, for example, without a washcoat layer, as a support of noble metals.

The third catalytic reforming zone can comprise a metal reforming catalyst. As mentioned above, the “metal catalyst” can be a precious metal catalyst, for example, noble metal catalyst, as explained above in connection with the second catalytic reforming zone. For example, it can comprise a nickel catalyst, for example, a Ni/C catalyst, as the actual reforming catalyst, as described in Pekka Simell, Catalytic hot gas cleaning of gasification gas, VTT Publications No. 330, Espoo 1997, the content of which is hereby incorporated by reference.

An exemplary process can comprise several catalyst beds within each catalytic zone. It can be possible to arrange the zirconium containing catalyst, the precious metal catalyst, for example, noble metal catalyst and the metal catalyst (or the third zone) in several catalyst beds which are arranged in series in the direction of the gas flow. The catalyst beds of one catalyst zone can be mutually similar or identical, but it is also possible to provide catalyst beds having catalysts materials with different properties.

In an exemplary embodiment, the metal catalyst of any upstream beds within the third catalyst zone can have a lower catalyst activity than the catalyst material downstream. It can be possible to arrange at least two catalyst beds in the third reforming zone such that in the flow direction the first bed comprises a nickel or cobalt, for example, nickel, catalyst and the second bed comprises a precious metal, for example, noble metal, having a higher activity than the nickel or cobalt catalyst.

A heat recovery device can be arranged, for example, between the catalyst beds. For example, the catalyst zones can have catalyst beds all of which comprise the same noble metals, or different catalysts, for example different noble metals can be used in the beds of sequential noble metal catalysts.

In an exemplary embodiment, the second catalyst zone can be arranged before the third catalyst zone, for example, the first, the second and the third catalyst zones can be arranged in that order (for example, in the numerical order).

An exemplary embodiment can be applied to the treatment of syngas used for Fischer-Tropsch or methanol synthesis.

The effluent obtained from the reformer outlet can be, for example, after the described reforming step, conducted to a gas-processing step which can be, for example, a gas cooling step; a step in which the gas is filtered to remove any remaining fines; a step in which the gas is subjected to gas washing with a physical or chemical washing means; a treatment in a catalyst guard bed or in a similar membrane or ion-exchange device; a step in which the proportion of hydrogen to carbon monoxide is changed—examples of such process include water gas shift (WGS) reactions and reversed water gas shift (RWGS) reactions; a step in which at least a part of gaseous components, such as carbon dioxide, is removed; or to a combination of two or more of these treatment steps. An exemplary reforming unit can be combined with an apparatus suitable for carrying out any of the listed additional gas-processing steps.

In an exemplary embodiment, impurities can be removed from the gas by gas washing using, for example, a copper sulphate containing washing liquid.

In an exemplary embodiment, impurities can be removed from the gas by gas washing using, for example, a combination of copper sulphate and methanol.

In an exemplary embodiment, impurities can be removed from the gas by gas washing using, for example, a combination of copper sulphate and an alkaline agent (for example, an amine).

Exemplary gas washing methods are disclosed in co-pending European Patent Application No. 11153704.9 (Method of Purifying Gas), filed on 2 Feb. 2011, the contents of which is hereby incorporated by reference.

In an exemplary embodiment, tarry compounds including naphthalene and benzene can be removed by any of the above steps or by other suitable gas washing steps.

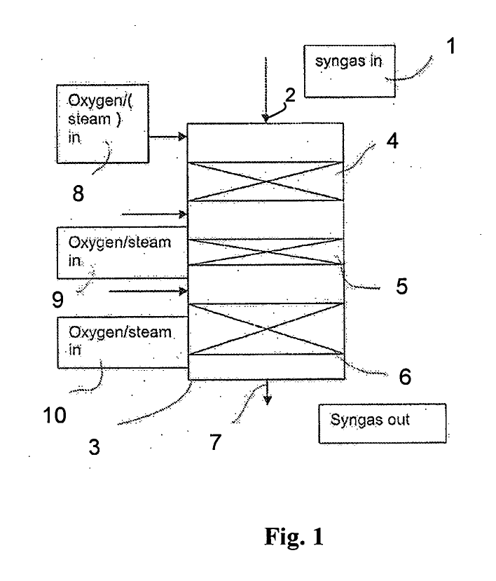

In an exemplary embodiment shown in FIG. 1, the reformer is designated reference numeral 3. The reformer can include a preliminary reforming zone 4, 5 which can comprise a zirconium zone and a precious metal zone, for example, noble metal zone, and a secondary reforming zone 6 which can comprise a metal catalyst such as, for example, nickel. The reforming unit can have a feed inlet 2 for introduction of the gasification gas, and an outlet pipe 7 for removing the reformed gas.

The feed of the reformer can comprise syngas 1. This gas which can comprise, for example, hydrogen and carbon monoxide can be generated in a gasifier (not shown), from a gasifiable fuel, such as biomass, with the help of a gasifying material. Air, oxygen or water vapor, or a mixture of two or more of these, can act as the gasifying material. The gasifying material can be fed into the gasifier from below and the fuel, which is heavier than air, from above. The gasifier can be a fluidized bed reactor, a circulating mass reactor or a similar reactor.

Before the syngas is led into the reforming zone, an oxidizing agent 8 can be fed into the gasification gas in order to generate reforming. If desired, any particles contained in the syngas can be separated already in this stage, or before the oxidizing component is added, for example, before the first reforming stage.

The gas can be conducted from the upper part of the reactor 3, via a feed pipe 2 into the zirconium material zone 4 of the reformer 3, in which it can be possible to efficiently purify the gasification gas of tar impurities and ammonia contained in it by using catalysts at a high temperature.

As shown in FIG. 1, the preliminary reforming zone can comprise two subsequent catalyst zones 4, 5, the first of which is a zirconium catalyst layer 4 and the second is a noble metal catalyst layer 5.

The pre-reforming zone 4, 5 can be installed in the direction of the gas flow in a position before the reforming catalyst 6, as shown in FIG. 1.

The oxidizing agent 8, such as oxygen gas, can be fed as such at the top of the reactor. It can be mixed with (water) steam before it is contacted with the syngas.

For example, for attaining good tar conversion in the zirconia zone, the temperature can be about 500 to 700° C., for example, about 600° C.

Additional oxidizing component (for example, oxygen gas) 9 can be fed into the gaseous effluent of the first catalyst zone before it is conducted into the next catalyst zone, in the case shown in the drawing the precious metal catalyst zone 5. As a result, in the precious metal catalyst zone, the temperature can be raised to about 800 to 900° C. to achieve high tar conversion. The oxygen can be diluted with steam to reduce the risk of damage caused to metal structures by oxygen feed in combination with high temperatures (temperatures in excess of 700° C.

Downstream of the preliminary reforming zone, the effluent can be conducted to the secondary reforming catalytic zone 6, which comprises nickel catalyst or another similar reforming catalyst.

As above, oxygen or air or other oxidizing component mixed with steam or another protective gas component 10 can be fed into the effluent of the previous catalytic zone 5 before it is fed into the metal catalytic zone 6. By addition feed of oxidizing component, the temperature can be raised to 900° C. before the metal catalytic zone 6, and inside the zone it can increase to a maximum temperature of about 950 to 980° C. After it has attained the maximum point, due to endothermic conditions, the temperature can drop to below 900° C., for example, about 850 to 870° C.

Although not explicitly shown in FIG. 1, each of the above catalytic zones can be divided into several successive catalyst beds, as already mentioned above. There can be additional, optional feed of oxidizing component between such beds.

In an exemplary embodiment, the metal catalyst zone 6, for example, nickel catalyst zone, can be divided into separate zones between which additional oxygen/steam can be fed. The performance of a metal catalyst such as nickel can be poor below 900° C. if there are high sulfur levels in the syngas. For example, in wood derived syngas, the sulfur levels can be about 50 to 300 ppm as H₂S. For example, it can be desirable to arrange a metal catalyst having higher activity at the bottom of the metal zone (for example, downstream of the feed). This highly active catalyst can be a precious metal catalyst, for example, noble metal catalyst, for example, one which is of the same kind as in catalyst zone 5.

The metal catalyst zone 6 can be divided in one or more zones in such a way that each one is constituted by noble metal catalyst layers and nickel catalyst layers.

The treatment of the gas can be carried out in separate reactors which are positioned in relation to the gas flow as described above.

During the reformation which can take place in the first two catalyst zone, the zirconia and noble metal catalyst zones, the light intermediate product compounds, for example ethylene and butadiene, which form carbon and very heavy tar compounds, can be decomposed.

The space velocity of the gas in the reformer can be 500 to 50,000 1/h, for example, approximately 1,000 to 20,000 1/h.

The effluent of the reformation can be of sufficient quality for use as a synthesis gas for diesel-category fuels or corresponding hydrocarbons. The effluent can be led through the outlet pipe 7 to further processing. In an exemplary embodiment, the outlet pipe 7 can be connected to a synthesis gas FT reactor (not shown).

### Example 1

### Pilot Scale Test

Feed gas was generated in a pilot scale gasifier using wood residual feed stock and oxygen blown gasifying. The reformer included three different catalyst beds including a Zr-catalyst bed at top, a precious metal catalyst in the middle and a nickel catalyst in bottom.

Syngas and oxygen feed were introduced to the top of the reactor and steam diluted oxygen feed between Zr-catalyst and precious metal catalyst and between precious metal catalyst and nickel catalyst layers.

The particle form Zr-catalyst layer was operated at a temperature in the range from 500 to 600° C. The feed NTP-WHSV was 5000/h.

The particle form precious metal catalyst layer was operated at a temperature in the range from 850 to 900° C. The catalyst NTP-WHSV was 15000/h.

The peak temperature of the particle form nickel catalyst peak temperature was between 950 to 1000° C. and gas outlet temperature was 850 to 900° C. The catalyst NTP-WHSV was 5000/h.

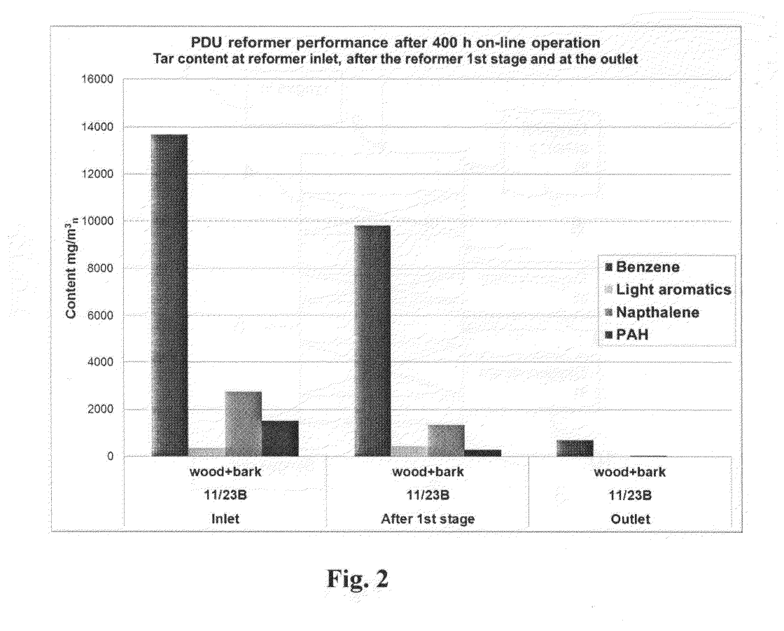

The operating pressure was from 4 to 6 bar(a). Over 400 operating hours was achieved with this configuration in two separate two week long test periods. The operation of the reformer was stable, temperatures could be controlled better that in two stage reformer, for example, during process disturbances. Tar conversions were very high and stable during the whole test series. No soot or other deposits were observed after the test on the catalyst surfaces. Test results at exemplary conditions after 400 h operation are presented in FIG. 2.

### Example 2

### Laboratory Test

The optimal operation conditions for the first stage zirconia catalyst were determined by microreactor fed with bottle gases. The dry composition of the feed gas was (vol.-%): CO 25%, CO₂ 20%, H₂ 35%, CH₄ 10%, N₂ 8% and as impurities C₂H₄ 20000 vol.-ppm, NH₃ 2000 vol.-ppm, H₂S 100 vol.-ppm, tar 20 g (Nm³).

The tar composition was 80 mass-% toluene, benzene 10 mass-% and naphthalene 10 mass-%.

The total feed flow rate to microreactor was 1.20 normal litres/min.

The La-doped ZrO₂ monolith catalyst was packed to a quartz reactor.

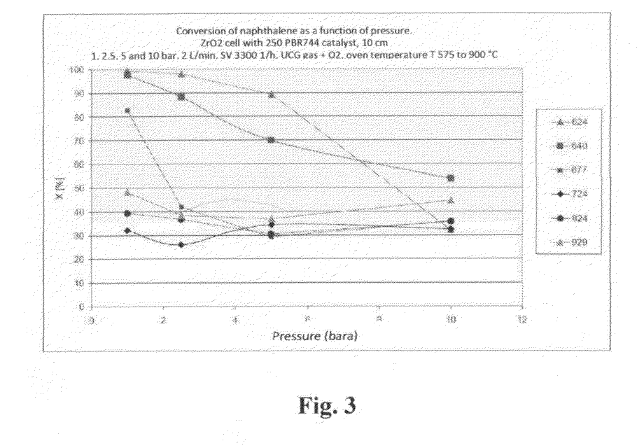

The naphthalene results shown in FIG. 3 indicates that the optimum operation temperature is 600° C.

### Example 3

The reactor set up was as shown in FIG. 1 except that no oxygen/steam was fed between the zirconium catalyst and the precious metal zones. The following conditions were employed, and tar concentrations and benzene conversion were measured.

### Reformer Temperature:

| | |
|---|---|
| Zr catalyst zone | 845° C. (in the middle) |
| Precious metal catalyst zone | 845° C. (in the middle) |
| Nickel catalyst zone | 970° C. (maximum point) |
| Reformer pressure 4 bar(a) | |
| Tar concentrations mg/m³n (dry gas) | |

| | reformer feed | after precious metal | reformer effluent |
|---|---|---|---|
| benzene | 11200 | 7100 | 960 |
| naphthalene | 2300 | 1200 | nd |
| heavy PAH | 1800 | 100 | nd |

Benzene conversion 91%

### Example 4

The reactor set up was as shown in FIG. 1 (oxygen/steam feed between the zirconium catalyst and the precious metal zones). The following conditions were employed, and tar concentrations and benzene conversion were measured.

### Reformer Temperature:

| | |
|---|---|
| Zr catalyst zone | 600° C. (in the middle) |
| Precious metal catalyst zone | 845° C. (in the middle) |
| Nickel catalyst zone | 970° C. (maximum point) |
| Reformer pressure 4 bar(a) | |
| Tar concentrations mg/m³n (dry gas) | |

| | reformer feed | after precious metal | reformer effluent |
|---|---|---|---|
| benzene | 8600 | 7000 | 200 |
| naphthalene | 1800 | 700 | nd |
| heavy PAH | 500 | 10 | nd |

Benzene conversion 98%

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of reforming gasification gas to decompose organic impurities comprised in the gasification gas, wherein the gasification gas is contacted with a metal catalyst in the presence of an oxidizing agent, the method comprising:
carrying out reforming of the gasification gas in several stages comprising, in a cascade,
a first catalyst zone comprising a zirconium containing catalyst;
a second catalyst zone comprising a precious metal catalyst; and
a third catalyst zone comprising a metal catalyst,
wherein a first oxidizing agent is fed into the first catalyst zone, and a second oxidizing agent is separately fed into the second catalyst zone, wherein the first and second oxidizing agents are of the same or different material.

2. The method according to claim 1, wherein a third oxidizing agent is separately fed into the third catalyst zone.

3. The method according to claim 1, wherein the second catalyst zone is arranged before the third catalyst zone.

4. The method according to claim 1, wherein at least one of the first and second oxidizing agents includes air, oxygen or a mixture thereof.

5. The method according to claim 2, wherein at least one of the first, second and third oxidizing agents is mixed with a protecting agent.

6. The method according to claim 1, wherein at least one of the catalyst zones comprises a plurality of catalyst beds, optionally arranged with an intermittent feed of an oxidizing agent.

7. The method according to claim 1, wherein the temperature of the first catalyst zone is about 500 to 700° C., the temperature of the second catalyst zone is about 750 to 900° C., and the temperature of the third catalyst zone is about 900 to 1000° C.

8. The method according to claim 1, wherein the zirconium catalyst stage comprises a zirconium catalyst which is arranged upstream of the second catalyst zone in order to protect the precious metal catalyst from coking.

9. The method according to claim 8, wherein the zirconium catalyst comprises a zirconium compound.

10. The method according to claim 9, wherein the zirconium catalyst comprises zirconium oxide which is alloyed with another metal oxide, or the zirconium compound is on a surface of an inert carrier or impregnated into a carrier.

11. The method according to claim 1, wherein a space velocity of gas during reforming is 500 to 50,000 1/h.

12. The method according to claim 1, wherein the precious metal catalyst includes at least one metal of groups 8 to 10 in the periodic table, either as a single component or as a combination of two or more metals.

13. The method according to claim 1, wherein at least one catalyst is a supported metal catalyst having a metal deposited on a surface of a support, wherein an amount of metal in the catalyst is in a range of 0.01 to 20% by weight, calculated from the weight of the support.

14. The method according to claim 1, wherein the effluent of the third catalyst zone is introduced to at least one gas processing step.

15. The method according to claim 14, wherein said gas processing step comprises at least one of a gas cooling step; a step in which a gas is filtered to remove any remaining fines; a step in which a gas is subjected to gas washing with a physical or chemical washing; a treatment in a catalyst guard bed or in a membrane or ion-exchange device; a step in which a proportion of hydrogen to carbon monoxide is changed; or a step in which at least a part of gaseous components is removed.

16. The method according to claim 1, wherein the first catalyst zone is arranged before the second catalyst zone, and the second catalyst zone is arranged before the third catalyst zone.

17. The method according to claim 2, wherein at least one of the first, second and third oxidizing agents is mixed with steam.

18. The method according to claim 2, wherein the second oxidizing agent is mixed with steam, the third oxidizing agent is mixed with steam, and the first oxidizing agent includes oxygen gas in essentially pure or purified form.

19. The method according to claim 6, wherein the at least one catalyst zone comprising a plurality of catalyst beds is arranged with an intermittent feed of an oxidizing agent mixed with steam.

20. The method according to claim 9, wherein the zirconium compound includes zirconium oxide.

21. The method according to claim 10, wherein the zirconium catalyst comprises zirconium oxide which is alloyed with aluminum oxide.

22. The method according to claim 1, wherein a space velocity of gas during reforming is approximately 1,000 to 20,000 1/h.

23. The method according to claim 1, wherein the precious metal catalyst includes at least one of Ru, Rh, Pd or Pt, either as a single component or as a combination of two or more metals.

24. The method according to claim 1, wherein at least one catalyst is a supported metal catalyst having a metal deposited on a surface of a support including aluminum oxide or zirconium oxide, wherein an amount of metal in the catalyst is in a range of 0.1 to 5% by weight, calculated from the weight of the support.
